(19) United States
(12) Patent Application Publication
(10) Pub. No.: US 2025/0389871 A1
(43) Pub. Date: Dec. 25, 2025

(54) FILM MIRROR LAMINATE AND MIRROR MEMBER

(71) Applicant: NITTO DENKO CORPORATION, Osaka (JP)

(72) Inventors: Kazuki Tanaka, Ibaraki-shi (JP); Gaku Tsuburaoka, Ibaraki-shi (JP); Tetsushi Murakami, Ibaraki-shi (JP)

(73) Assignee: NITTO DENKO CORPORATION, Osaka (JP)

(21) Appl. No.: 19/238,702

(22) Filed: Jun. 16, 2025

(30) Foreign Application Priority Data
Jun. 21, 2024 (JP) 2024-100811

(51) Int. Cl. G02B 5/08; G02B 1/18

(52) U.S. Cl. CPC G02B 5/0808; G02B 1/18; G02B 5/0883

(57) ABSTRACT

A film mirror laminate (1) includes a substrate film (2), a metal reflective layer (3), a reflection adjustment layer (4), and a water-repellent layer (5) in order toward one side in a thickness direction. The reflection adjustment layer (4) includes a silicon oxide layer (43), and the water-repellent layer (5) is disposed on one surface in the thickness direction of the silicon oxide layer (43). Further, a water contact angle in one surface in the thickness direction of the water-repellent layer (5) is 110° or more.

### CROSS-REFERENCE TO RELATED APPLICATION

The present application claims priority from Japanese Patent Application No. 2024-100811 filed on Jun. 21, 2024, the contents of which are hereby incorporated by reference into this application.

### TECHNICAL FIELD

The present invention relates to a film mirror laminate and a mirror member.

### BACKGROUND ART

Recently, AR (Augmented Reality) technology has attracted attention, and head-up display devices using the AR technology have been developed. The head-up display device is a device which forms a virtual image in front of a driver of a vehicle such as an automobile, and displays traffic information such as route information and congestion information, and vehicle information such as an amount of fuel remaining and a cooling water temperature.

In the head-up display device, an image from a light source such as a liquid crystal display is reflected to a mirror body (reflecting mirror), so that it is visually recognized by the driver as the virtual image. As the reflecting mirror used in such a head-up display device, an aluminum surface reflecting mirror including an aluminum layer, a SiO₂ layer (first low refractive index layer), a ZrO₂ layer (high refractive index layer), and a SiO₂ layer (second low refractive index layer) in order on a substrate such as glass has been proposed (ref: for example, Patent Document 1).

### CITATION LIST

### Patent Document

Patent Document 1: Japanese Unexamined Patent Publication No. H5-173005

### SUMMARY OF THE INVENTION

### Problem to be Solved by the Invention

However, in the aluminum surface reflecting mirror described in Patent Document 1, corrosion might occur in the aluminum layer, and there is a risk that adhesion between the layers decreases.

The present invention provides a film mirror laminate and a mirror member capable of suppressing corrosion of a metal reflective layer, and suppressing a decrease in adhesion between the layers.

### Means for Solving the Problem

The present invention [1] includes a film mirror laminate including a substrate film, a metal reflective layer, a reflection adjustment layer, and a water-repellent layer in order toward one side in a thickness direction, wherein the reflection adjustment layer includes a silicon oxide layer, the water-repellent layer is disposed on one surface in the thickness direction of the silicon oxide layer, and a water contact angle in one surface in the thickness direction of the water-repellent layer is 110° or more.

The present invention [2] includes the film mirror laminate described in the above-described [1], wherein a reflection rate of a visible ray at a wavelength of 360 to 740 nm irradiated from one side in the thickness direction of the film mirror laminate is 95.0% or more.

The present invention [3] includes the film mirror laminate described in the above-described [1] or [2], wherein the metal reflective layer includes at least one metal selected from the group consisting of aluminum (Al), zinc (Zn), lead (Pb), copper (Cu), and silver (Ag).

The present invention [4] includes the film mirror laminate described in any one of the above-described [1] to [3], wherein the reflection adjustment layer includes a low refractive index layer, a high refractive index layer, and the silicon oxide layer in order toward one side in the thickness direction.

The present invention [5] includes the film mirror laminate described in any one of the above-described [1] to [4], wherein the silicon oxide layer has a thickness of 50 nm or less.

The present invention [6] includes the film mirror laminate described in any one of the above-described [1] to [5], wherein the water-repellent layer is a dry coating layer.

The present invention [7] includes a mirror member including a support substrate, a pressure-sensitive adhesive layer, and the film mirror laminate described in any one of the above-described [1] to [6] in order toward one side in a thickness direction.

### Effect of the Invention

The film mirror laminate of the present invention includes the substrate film, the metal reflective layer, the reflection adjustment layer, and the water-repellent layer in order toward one side in the thickness direction; the reflection adjustment layer includes the silicon oxide layer; the water-repellent layer is disposed on one surface in the thickness direction of the silicon oxide layer; and the water contact angle in one surface in the thickness direction of the water-repellent layer is 110° or more. Therefore, it is possible to suppress corrosion of the metal reflective layer, and to suppress a decrease in adhesion between the layers.

The mirror member of the present invention includes the support substrate, the pressure-sensitive adhesive layer, and the above-described film mirror laminate in order toward one side in the thickness direction. Therefore, it is possible to suppress the corrosion of the metal reflective layer, and to suppress the decrease in the adhesion between the layers. As a result, reliability of the mirror member is improved.

### BRIEF DESCRIPTION OF THE DRAWINGS

FIG. 1 shows a cross-sectional view of one embodiment of a film mirror laminate of the present invention.

FIG. 2 shows a cross-sectional view of a mirror member using the film mirror laminate shown in FIG. 1.

### DESCRIPTION OF EMBODIMENTS

### 1. Film Mirror Laminate

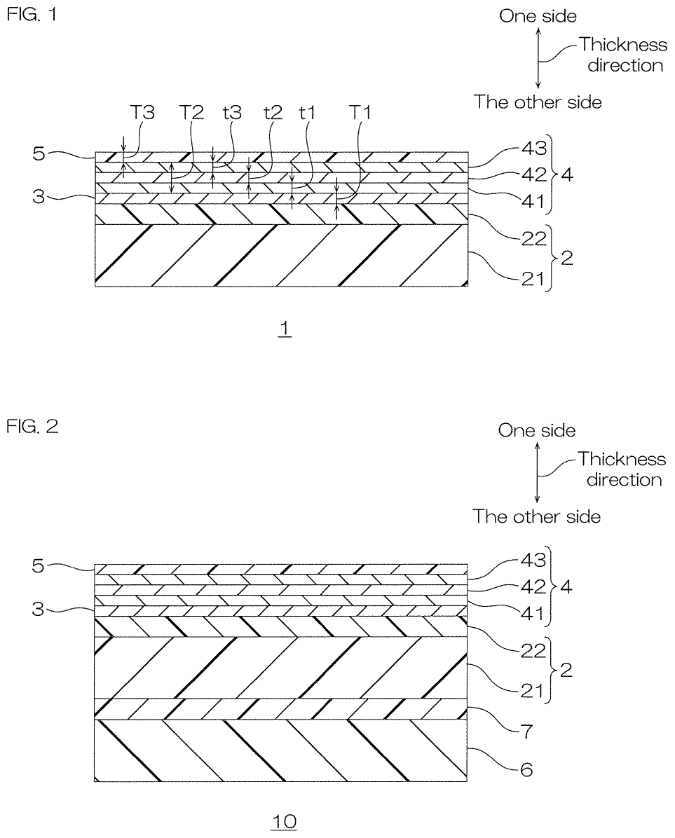

One embodiment of a film mirror laminate of the present invention is described with reference to FIG. 1.

As shown in FIG. 1, a film mirror laminate 1 has a film shape having a predetermined thickness (including a sheet shape). Further, the film mirror laminate 1 extends in a plane direction perpendicular to a thickness direction (a first direction and a second direction perpendicular to the first direction), and one surface in the thickness direction and the other surface in the thickness direction of the film mirror laminate 1 are flat.

The film mirror laminate 1 includes a substrate film 2, a metal reflective layer 3, a reflection adjustment layer 4, and a water-repellent layer 5 in order toward one side in the thickness direction. Specifically, as shown in FIG. 1, the film mirror laminate 1 includes the substrate film 2, the metal reflective layer 3 disposed on one surface in the thickness direction of the substrate film 2, the reflection adjustment layer 4 disposed on one surface in the thickness direction of the metal reflective layer 3, and the water-repellent layer 5 disposed on one surface in the thickness direction of the reflection adjustment layer 4.

### <Substrate Film>

The substrate film 2 is the lowermost layer of the film mirror laminate 1, and supports the film mirror laminate 1. The substrate film 2 includes a transparent resin film 21. Further, the substrate film 2, if necessary, further includes a cured resin layer 22 which is disposed on one surface in the thickness direction and/or the other surface in the thickness direction of the transparent resin film 21. In the present embodiment, the substrate film 2 includes the transparent resin film 21 and the cured resin layer 22 disposed on one surface in the thickness direction of the transparent resin film 21.

The transparent resin film 21 has the film shape (including the sheet shape). Further, the transparent resin film 21 is, for example, a transparent resin film having flexibility.

Examples of a material for the transparent resin film 21 include cellulose resins, polyester resins, (meth)acrylic resins (acrylic resins and/or methacrylic resins), olefin resins, polycarbonate resins, polyether sulfone resins, polyarylate resins, melamine resins, polyamide resins, polyimide resins, polystyrene resins, norbornene resins, and polyvinyl alcohol resins. Preferably, a polyester resin, a polyolefin resin, and a cellulose resin are used. Examples of the polyester resin include polyethylene terephthalate (PET), polybutylene terephthalate, and polyethylene naphthalate.

Examples of the polyolefin resin include polyethylene, polypropylene, and cycloolefin polymers (COP). An example of the cellulose resin includes triacetyl cellulose (TAC). From the viewpoint of transparency, heat resistance, mechanical strength, and the like, the transparent resin film 21 is preferably at least one selected from the group consisting of PET films, COP films, and TAC films. More preferably, the transparent resin film 21 is the PET film. These materials for the transparent resin film 21 may be used alone or in combination of two or more.

Total light transmittance (JISK-7105) of the transparent resin film 21 is, for example, 80% or more, preferably 85% or more, more preferably 90% or more, and for example, 100% or less.

A thickness of the transparent resin film 21 is not particularly limited, and is, from the viewpoint of strength and handleability, for example, 10 μm or more, preferably 30 μm or more, more preferably 50 μm or more, and for example, 300 μm or less, preferably 200 μm or less, more preferably 150 μm or less.

The thickness of the transparent resin film 21 can be, for example, measured using a film thickness meter.

The cured resin layer 22 is a layer which improves mechanical properties of the film mirror laminate 1. The cured resin layer 22 is, for example, in contact with one surface in the thickness direction of the transparent resin film 21.

Examples of the cured resin layer 22 include hard coat layers and anti-blocking layers. The hard coat layer, for example, hardly causes scratches to be formed on the exposed surface of the transparent resin film 21. The anti-blocking layer, for example, imparts blocking resistance to each of the surfaces of the plurality of film mirror laminates 1 in contact with each other when the film mirror laminates 1 are laminated in the thickness direction.

The cured resin layer 22 is, for example, a cured product of a curable resin composition. Specifically, the cured resin layer 22 can be formed by coating the curable resin composition onto one surface in the thickness direction of the transparent resin film 21 to be dried if necessary, and then, being cured.

The curable resin composition contains a curable resin. Examples of the curable resin include polyester resins, acrylic urethane resins, acrylic resins (excluding the acrylic urethane resins), urethane resins (excluding the acrylic urethane resins), amide resins, silicone resins, epoxy resins, and melamine resins. Preferably, an acrylic urethane resin is used. These curable resins may be used alone or in combination of two or more.

Further, examples of the curable resin composition include ultraviolet curable resin compositions and thermosetting resin compositions. As the curable resin composition, from the viewpoint of production efficiency, preferably, an ultraviolet curable resin composition is used. The ultraviolet curable resin composition includes at least one selected from the group consisting of an ultraviolet curable monomer, an ultraviolet curable oligomer, and an ultraviolet curable polymer. A specific example of the ultraviolet curable resin composition includes a composition for forming a hard coat layer described in Japanese Unexamined Patent Publication No. 2016-179686.

The curable resin composition preferably contains particles from the viewpoint of adjusting hardness, adjusting surface roughness, adjusting a refractive index, and imparting antiglare property in the cured resin layer 22. Examples of the particles include inorganic particles and organic particles. Preferably, inorganic particles are used. Examples of the inorganic particles include inorganic oxide particles. Examples of the material for the inorganic oxide particles include silica, alumina, titania, zirconia, calcium oxide, tin oxide, indium oxide, cadmium oxide, and antimony oxide. Preferably, silica is used. Examples of the material for the organic particles include polymethyl methacrylate, polystyrene, polyurethane, acrylic-styrene copolymers, benzoguanamine, melamine, and polycarbonate.

A number average primary particle size of the particles is, for example, 5 nm or more, preferably 10 nm or more, and for example, 150 nm or less, preferably 100 nm or less.

The curable resin composition preferably contains a photopolymerization initiator. Further, the curable resin composition may also contain additives such as a solvent, a leveling agent, a thixotropic agent, and an antistatic agent.

The thickness of the cured resin layer 22 is, for example, 0.5 μm or more, preferably 1.0 μm or more, and for example, 10 μm or less, preferably 5 μm or less.

When the thickness of the cured resin layer 22 is the above-described lower limit value or more, it is possible to sufficiently exhibit a function of the cured resin layer 22. Further, when the thickness of the cured resin layer is the above-described upper limit value or less, it is possible to achieve thinning of the film mirror laminate 1.

One surface in the thickness direction of the substrate film 2 (one surface in the thickness direction of the cured resin layer 22) may be also subjected to a surface modification treatment from the viewpoint of improving adhesion to the metal reflective layer 3 to be described later. Examples of the surface modification treatment include corona treatments, plasma treatments, ozone treatments, primer treatments, glow treatments, and coupling agent treatments. Preferably, a plasma treatment is used. That is, one surface in the thickness direction of the substrate film 2 (one surface in the thickness direction of the cured resin layer 22) is preferably a plasma treatment surface.

The total light transmittance (JISK-7105) of the substrate film 2 is, for example, 80% or more, preferably 85% or more, more preferably 90% or more, and for example, 100% or less.

The thickness of the substrate film 2 is not particularly limited, and is, from the viewpoint of the strength and the handleability, for example, 10 μm or more, preferably 30 μm or more, more preferably 50 μm or more, and for example, 300 μm or less, preferably 200 μm or less, more preferably 150 μm or less.

### <Metal Reflective Layer>

The metal reflective layer 3 is a metal layer having light reflectivity. The metal reflective layer 3 is in contact with one surface in the thickness direction of the substrate film 2. In the present embodiment, the metal reflective layer 3 is in contact with one surface in the thickness direction of the cured resin layer 22.

An example of the material for the metal reflective layer 3 includes a metal having the light reflectivity. Specifically, the metal reflective layer 3 includes at least one metal selected from the group consisting of, for example, aluminum (Al), zinc (Zn), lead (Pb), copper (Cu), and silver (Ag), or two or more alloys of these metals. Preferably, the material for the metal reflective layer 3 includes aluminum or aluminum alloys. The metal reflective layer 3 is, from the viewpoint of the light reflectivity, more preferably an aluminum layer. The aluminum alloy is an alloy having the aluminum content of 50% by mass or more.

The metal reflective layer 3 is, for example, a layer formed by a dry coating method (dry coating layer). Examples of the dry coating method include sputtering methods, vacuum deposition methods, and CVD. Preferably, a sputtering method is used. That is, as the metal reflective layer 3, preferably, a dry coating layer is used. More preferably, a layer formed by a sputtering method (sputtering layer) is used.

A thickness T1 of the metal reflective layer 3 is, for example, 10 nm or more, preferably 20 nm or more, more preferably 30 nm or more, and for example, 100 nm or less, preferably 90 nm or less, more preferably 80 nm or less.

When the thickness T1 of the metal reflective layer 3 is the above-described lower limit or more, it is possible to have the appropriate light reflectivity. Further, when the thickness T1 of the metal reflective layer 3 is the above-described upper limit or less, it is possible to easily form the metal reflective layer 3 having the uniform thickness, and to suppress scattering of light or the like.

### <Reflection Adjustment Layer>

As the details are described later, the reflection adjustment layer 4 is a layer which adjusts reflected light intensity. The reflection adjustment layer 4 is in contact with the metal reflective layer 3.

The reflection adjustment layer 4 includes a silicon oxide layer 43 at the most-one side in the thickness direction. That is, of the reflection adjustment layer 4, the silicon oxide layer 43 is disposed at a position furthest from the metal reflective layer 3 in the thickness direction.

Since the reflection adjustment layer 4 includes the silicon oxide layer 43 on the most-one side in the thickness direction, it is possible to improve the adhesion to the water-repellent layer 5 to be described later.

In the present embodiment, the reflection adjustment layer 4 includes a low refractive index layer 41 (first layer), a high refractive index layer 42 (second layer), and the silicon oxide layer 43 (third layer) in order toward one side in the thickness direction. In other words, the low refractive index layer 41 (the first layer) is in contact with the metal reflective layer 3. The high refractive index layer 42 (the second layer) is in contact with the low refractive index layer 41 (the first layer). The silicon oxide layer 43 (the third layer) is in contact with the high refractive index layer 42 (the second layer). The low refractive index layer 41 is a layer having a relatively low refractive index, and the high refractive index layer 42 is a layer having a relatively high refractive index.

Since the reflection adjustment layer 4 includes the low refractive index layer 41, the high refractive index layer 42, and the silicon oxide layer 43 in order toward one side in the thickness direction, and the thickness of each layer is adjusted as described later, it is possible to align phases between the reflected lights at a plurality of interfaces, and to increase the net reflected light intensity. Therefore, when the reflection adjustment layer 4 is used as a mirror member 10, it is possible to improve visibility of an image reflected by the mirror member 10.

As shown in FIG. 1, in the present embodiment, the reflection adjustment layer 4 has three layers, and as long as the above-described effect (the phases between the reflected lights at the plurality of interfaces are aligned, and the net reflected light intensity is increased) is achieved, the number of layers is not particularly limited. The number of layers of the reflection adjustment layer 4 is, for example, three layers, four layers, and five or more layers. Preferably, the number of layers thereof is three layers.

The low refractive index layer 41 (the first layer) is made of a low refractive index material having a refractive index at the wavelength of 550 nm of, for example, 1.6 or less. Examples of the low refractive index material include silicon oxide (SiOx) and magnesium fluoride from the viewpoint of achieving both the low refractive index and low absorptivity of a visible ray, and preferably, silicon oxide (SiOx) is used.

Examples of the silicon oxide (SiOx) include silicon oxides with X=2 (silicon dioxide) and silicon oxides with X<2. Preferably, silicon dioxide is used.

In other words, as the low refractive index layer 41 (the first layer), preferably, a first silicon oxide layer is used, more preferably, a first silicon dioxide layer is used. The refractive index at the wavelength of 550 nm of the silicon dioxide layer is 1.46. Further, the first silicon oxide layer as the low refractive index layer 41 is a layer made of the silicon oxide, and may also contain a trace amount of unavoidable impurities.

A thickness t1 of the low refractive index layer 41 (the first layer) is, for example, 10 nm or more, preferably 30 nm or more, and for example, 150 nm or less, preferably 100 nm or less. An optical film thickness (product of the refractive index and the thickness) of the low refractive index layer 41 (the first layer) is, for example, 50 nm or more, and for example, 150 nm or less.

The high refractive index layer 42 (the second layer) is made of a high refractive index material having the refractive index at the wavelength of 550 nm of, for example, 1.9 or more. Examples of the high refractive index material include niobium oxide (Nb₂O₅), titanium oxide, zirconium oxide, indium-tin complex oxide (ITO), and antimony tin complex oxide (ATO) from the viewpoint of achieving both the high refractive index and the low absorptivity of the visible ray, and preferably, niobium oxide is used.

In other words, as the high refractive index layer 42 (the second layer), preferably, a niobium oxide layer is used. The refractive index at the wavelength of 550 nm of the niobium oxide layer is 2.33. Further, the niobium oxide layer as the high refractive index layer 42 is a layer made of the niobium oxide, and may also contain the trace amount of unavoidable impurities.

A thickness t2 of the high refractive index layer 42 (the second layer) is, for example, 10 nm or more, preferably 25 nm or more, and for example, 130 nm or less, preferably 80 nm or less. The optical film thickness (product of the refractive index and the thickness) of the high refractive index layer 42 (the second layer) is, for example, 70 nm or more, and for example, 170 nm or less.

The silicon oxide layer 43 (the third layer) is a layer made of the silicon oxide. The refractive index at the wavelength of 550 nm of the silicon oxide layer 43 (the third layer) is 1.6 or less. That is, the silicon oxide layer 43 (the third layer) is one of the low refractive index layers. When the low refractive index layer 41 (the first layer) is the first silicon oxide layer, the silicon oxide layer 43 (the third layer) is the second silicon oxide layer. In addition, the silicon oxide layer 43 may also contain the trace amount of unavoidable impurities.

Examples of the silicon oxide (SiOx) include silicon oxides with X=2 (silicon dioxide) and silicon oxides with X<2. Preferably, silicon dioxide is used.

In other words, as the silicon oxide layer 43 (the third layer), preferably, a second silicon dioxide layer is used. The refractive index at the wavelength of 550 nm of the silicon dioxide layer is 1.46.

A thickness t3 of the silicon oxide layer 43 (the third layer) is, for example, 1 nm or more, preferably 5 nm or more, more preferably 10 nm or more, further more preferably 15 nm or more, and for example, 50 nm or less, preferably 40 nm or less, more preferably 35 nm or less, further more preferably 30 nm or less.

The thickness t3 of the silicon oxide layer 43 (the third layer) is, for example, 1 nm to 50 nm, preferably 5 nm to 40 nm, more preferably 10 nm to 35 nm, further more preferably 15 nm to 30 nm.

When the thickness t3 of the silicon oxide layer 43 (the third layer) is within the above-described range, it is possible to improve the adhesion to the water-repellent layer 5.

The optical film thickness (product of the refractive index and the thickness) of the silicon oxide layer 43 (the third layer) is, for example, 20 nm or more, and for example, 40 nm or less.

The reflection adjustment layer 4 is, for example, a layer formed by the dry coating method (dry coating layer). Examples of the dry coating method include sputtering methods, vacuum deposition methods, and CVD. Preferably, a sputtering method is used. That is, as the reflection adjustment layer 4, preferably, a dry coating layer is used. More preferably, a layer formed by a sputtering method (sputtering layer) is used.

A total thickness T2 (in the present embodiment, corresponding to t1+t2+t3) of the reflection adjustment layer 4 is, for example, 50 nm or more, preferably 80 nm or more, more preferably 100 nm or more, and for example, 300 nm or less, preferably 250 nm or less, more preferably 200 nm or less.

A ratio (t1/T2×100) of the thickness t1 of the low refractive index layer 41 (the first layer) in the total thickness T2 of the reflection adjustment layer 4 is, for example, 30% or more, preferably 40% or more, and for example, 70% or less, preferably 60% or less.

The ratio (t2/T2×100) of the thickness t2 of the high refractive index layer 42 (the second layer) in the total thickness T2 of the reflection adjustment layer 4 is, for example, 20% or more, preferably 30% or more, and for example, 60% or less, preferably 50% or less, more preferably 40% or less.

The ratio (t3/T2×100) of the thickness t3 of the silicon oxide layer 43 (the third layer) in the total thickness T2 of the reflection adjustment layer 4 is, for example, 5% or more, preferably 10% or more, and for example, 30% or less, preferably 20% or less.

The thickness t3 of the silicon oxide layer 43 (the third layer) is thinner than the thickness t1 of the low refractive index layer 41 (the first layer). Further, the thickness t3 of the silicon oxide layer 43 (the third layer) is thinner than the thickness t2 of the high refractive index layer 42 (the second layer).

By adjusting the total thickness T2 of the reflection adjustment layer 4, the thickness t1 of the low refractive index layer 41, the thickness t2 of the high refractive index layer 42, and the thickness t3 of the silicon oxide layer 43 within the above-described range, it is possible to align the phases between the reflected lights at the plurality of interfaces, and to increase the net reflected light intensity. Therefore, when the reflection adjustment layer 4 is used as the mirror member 10, it is possible to improve the visibility of the image reflected by the mirror member 10.

One surface in the thickness direction of the silicon oxide layer 43 (surface with which the water-repellent layer 5 is in contact) may be also subjected to the surface modification treatment. Examples of the surface modification treatment include corona treatments, plasma treatments, ozone treatments, primer treatments, glow treatments, and coupling agent treatments.

### <Water-Repellent Layer>

The water-repellent layer 5 has water repellency to water droplets. Further, the water-repellent layer 5 prevents contamination from the external environment, and further facilitates removal of the adhered contaminants. The water-repellent layer 5 is disposed on one surface in the thickness direction of the silicon oxide layer 43. The water-repellent layer 5 is in contact with the silicon oxide layer 43. The water-repellent layer 5 is the top most layer of the film mirror laminate 1.

Since the top most layer of the film mirror laminate 1 is the water-repellent layer 5, even when the reflection adjustment layer 4 (especially, the silicon oxide layer 43) is relatively thin, it is possible to suppress occurrence of corrosion by the water droplets.

As the material for the water-repellent layer 5, an organic fluorine compound having a terminal structure (terminal structure E) represented by the chemical formula CF₃OCF₂— is used. In other words, the water-repellent layer 5 contains the organic fluorine compound having the terminal structure E. As such an organic fluorine compound, preferably, an alkoxysilane compound having a perfluoropolyether skeleton is used. An example of the alkoxysilane compound having the terminal structure E and having the perfluoropolyether skeleton includes a compound represented by the following general formula (1).

$${CF}_{3} - {OCF}_{2} - R 1 - X - {( {CH}_{2} )}_{m} - {Si ( {OR}_{2} )}_{3} \qquad ( 1 )$$

R1 represents a structure including at least one repetition structure of a perfluoropolyether (PFPE) group, and preferably represents a structure including two repetition structures of the PFPE group. Examples of the repetition structure of the PFPE group include repetition structures of a linear PFPE group and repetition structures of a branched PFPE group. An example of the repetition structure of the linear PFPE group includes a structure represented by —(OCₙF₂ₙ)ₚ— (n represents an integer of 1 or more and 20 or less and p represents an integer of 1 or more and 100 or less, hereinafter, the same applies). Examples of the repetition structure of the branched PFPE group include a structure represented by —(OC(CF₃)₂)p— and a structure represented by —(OCF₂CF(CF₃)CF₂)ₚ—. As the repetition structure of the PFPE group, preferably, a repetition structure of a linear PFPE group is used. More preferably, —(OCF₂)ₚ— and —(OC₂F₄)ₚ— are used. R2 is, for example, an alkyl group having 1 or more and 4 or less carbon atoms. Preferably, R2 is a methyl group. Examples of X include ether groups, carbonyl groups, amino groups, and amide groups. Preferably, X is an ether group. m is an integer of, for example, 1 to 20, preferably 1 to 10, more preferably 1 to 5.

These alkoxysilane compounds having the perfluoropolyether skeleton may be used alone or in combination of two or more.

When the water-repellent layer 5 contains the alkoxysilane compound having the perfluoropolyether skeleton, it is possible to improve the water repellency of the water-repellent layer 5.

The water-repellent layer 5 may be a layer formed by the dry coating method (dry coating layer), and may be a layer formed by a wet coating method (wet coating layer). Examples of the dry coating method include sputtering methods, vacuum deposition methods, and CVD. Preferably, a vacuum deposition method is used. In other words, as the water-repellent layer 5, preferably, a dry coating layer is used. More preferably, a layer formed by the vacuum deposition method (vacuum deposition layer) is used.

The water contact angle (pure water contact angle) in one surface (exposed surface) in the thickness direction of the water-repellent layer 5 is 110° or more, preferably 111° or more, more preferably 112° or more, further more preferably 115° or more, particularly preferably 117° or more, and for example, 130° or less.

The water contact angle (pure water contact angle) in one surface (exposed surface) in the thickness direction of the water-repellent layer 5 is, for example, 110° to 130°, preferably 111° to 130°, more preferably 112° to 130°, further more preferably 115° to 130°, particularly preferably 117° to 130°.

When the water contact angle in one surface in the thickness direction of the water-repellent layer 5 is the above-described lower limit value or more, it has the high water repellency. Therefore, it is possible to suppress the corrosion of the metal reflective layer 3 by the water droplets (tap water droplets), and to suppress the decrease in the adhesion between the layers.

The water contact angle can be determined by a method described in Examples to be described later. The water contact angle of the outer surface of the water-repellent layer 5 can be adjusted, for example, by the composition of the water-repellent layer 5, a method for forming the water-repellent layer 5, and the composition of another layer.

A thickness T3 of the water-repellent layer 5 is, for example, 1 nm or more, preferably 3 nm or more, more preferably 5 nm or more, and for example, 50 nm or less, preferably 20 nm or less, more preferably 10 nm or less, further more preferably 7 nm or less.

The ratio (T3/t3) of the thickness T3 of the water-repellent layer 5 to the thickness t3 of the silicon oxide layer 43 is, for example, 0.10 or more, preferably 0.15 or more, more preferably 0.20 or more, and for example, 0.80 or less, preferably 0.60 or less, more preferably 0.50 or less, further more preferably 0.40 or less.

The thickness T3 of the water-repellent layer 5 is preferably thinner than the thickness t3 of the silicon oxide layer 43.

The water-repellent layer 5 preferably has a small difference in refractive index with a layer with which the water-repellent layer 5 is in contact (the silicon oxide layer 43). The refractive index of the water-repellent layer 5 is, for example, 1.6 or less, preferably 1.55 or less.

The thickness of the film mirror laminate 1 is, for example, 10 μm or more, preferably 30 μm or more, more preferably 50 μm or more, and for example, 300 μm or less, preferably 200 μm or less, more preferably 150 μm or less.

In the film mirror laminate 1, the ratio (T1/T2) of the thickness T1 of the metal reflective layer 3 to the thickness T2 of the reflection adjustment layer 4 is, for example, 0.1 or more, preferably 0.2 or more, more preferably 0.3 or more, and for example, 0.7 or less, preferably 0.5 or less, more preferably 0.4 or less.

In the film mirror laminate 1, the ratio (T3/T2) of the thickness T3 of the water-repellent layer 5 to the thickness T2 of the reflection adjustment layer 4 is, for example, 0.01 or more, preferably 0.02 or more, more preferably 0.03 or more, and for example, 0.20 or less, preferably 0.10 or less, more preferably 0.08 or less.

A reflection rate of the visible ray at the wavelength of 360 to 740 nm irradiated from one side in the thickness direction of the film mirror laminate 1 is, for example, 95.0% or more, preferably 95.5% or more, more preferably 96.0% or more.

The reflection rate of the visible ray at the wavelength of 360 to 740 nm irradiated from one side in the thickness direction of the film mirror laminate 1 can be measured by the method described in Examples to be described later.

The film mirror laminate 1 may also include another layer other than the above-described layers in accordance with its application. Examples of another layer include protective layers and antiglare layers.

### <Method for Producing Film Mirror Laminate>

The above-described film mirror laminate 1 can be produced by preparing the substrate film 2, and forming the metal reflective layer 3, the reflection adjustment layer 4, and the water-repellent layer 5 in order on the substrate film 2. In the present embodiment, the reflection adjustment layer 4 can be formed by laminating the low refractive index layer 41, the high refractive index layer 42, and the silicon oxide layer 43 in order.

That is, the method for producing the film mirror laminate 1 includes, for example, a step of preparing the substrate film 2 (preparation step), a step of forming the metal reflective layer 3 on the substrate film 2 (metal reflective layer forming step), a step of forming the reflection adjustment layer 4 on the metal reflective layer 3 (reflection adjustment layer forming step), and a step of forming the water-repellent layer 5 on the reflection adjustment layer 4 (water-repellent layer forming step).

The substrate film 2 can be fabricated by preparing the transparent resin film 21 and forming the cured resin layer 22 on one surface in the thickness direction of the transparent resin film 21. Specifically, the cured resin layer 22 is formed by coating the above-described curable resin composition on one surface in the thickness direction of the transparent resin film 21 to form a coating film, and thereafter, by curing the coating film.

When the curable resin composition contains a solvent, the coating film on the transparent resin film 21 is dried after the coating of the curable resin composition. A drying temperature is, for example, 50° C. to 120° C. Further, drying time is, for example, 10 seconds to 10 minutes.

When the curable resin composition contains an ultraviolet curable resin, the coating film on the transparent resin film 21 is cured by ultraviolet irradiation. Examples of a light source of the ultraviolet irradiation include high pressure mercury lamps and LED lights. An integrated amount of irradiated ultraviolet rays is, for example, 100 mJ/cm² to 500 mJ/cm². In addition, when the curable resin composition contains a thermosetting resin, the coating film on the transparent resin film 21 is cured by heating.

One surface in the thickness direction of the substrate film 2 (one surface in the thickness direction of the cured resin layer 22) is, if necessary, subjected to the surface modification treatment. As the surface modification treatment, when the plasma treatment is carried out, for example, a sputter film forming apparatus (magnetron sputter film forming apparatus) is used which is capable of carrying out a film forming process in a roll-to-roll method. Specifically, an inert gas (for example, argon) is introduced under vacuum conditions (for example, under the conditions with a degree of ultimate vacuum of 1.5×10⁻⁴ Pa or less, hereinafter, the same applies), and one surface in the thickness direction of the substrate film 2 is subjected to the plasma treatment. Further, the effective power density of the plasma treatment is, for example, 0.005 W·min/cm²·m to 1.00 W·min/cm²·m. The effective power density is a value obtained by dividing the power density (W/cm²) of a plasma outlet by a conveyance rate (m/min) of the substrate film 2 by the roll-to-roll method.

The metal reflective layer 3 can be formed by film-forming the material for the metal reflective layer 3 on the substrate film 2. Further, the reflection adjustment layer 4 can be formed by film-forming the material for the reflection adjustment layer 4 on the metal reflective layer 3. The reflection adjustment layer 4 can be formed by laminating each of the low refractive index layer 41, the high refractive index layer 42, and the silicon oxide layer 43 in order. The metal reflective layer 3 and the reflection adjustment layer 4 (the low refractive index layer 41, the high refractive index layer 42, and the silicon oxide layer 43) are preferably formed in series.

Each of the metal reflective layer 3 and the reflection adjustment layer 4 can be formed by, for example, film-forming each of the materials by the dry coating method. Examples of the dry coating method include sputtering methods, vacuum deposition methods, and CVD. Preferably, a sputtering method is used.

In the sputtering method, the sputter film forming apparatus (magnetron sputter film forming apparatus) is used which is capable of carrying out the film forming process in the roll-to-roll method. In a film forming chamber in the sputter film forming apparatus, a negative voltage is applied to a target disposed on a cathode, while a gas is introduced under the vacuum conditions. In this way, gas atoms are ionized by generating a glow discharge, the gas ions collide with the target surface at a high speed, and the target material is ejected from the target surface, thereby depositing the ejected target material on a predetermined surface. Examples of the gas include inert gases. Examples of the inert gas include argon, krypton, xenon, and mixed gas of these.

Examples of the target material include materials for the metal reflective layer 3 and materials for the reflection adjustment layer 4 (the low refractive index layer 41, the high refractive index layer 42, and the silicon oxide layer 43).

In order to form the metal (semimetal) oxide layer, the film-forming may be carried out using a sintered body of the metal (semimetal) oxide as the target material, or the film-forming may be carried out by reactive sputtering using the metal (semimetal) material as the target material.

Preferably, the film-forming is carried out by the reactive sputtering using the metal (semimetal) material from the viewpoint of film forming rate. In the present embodiment, the low refractive index layer 41 and the silicon oxide layer 43 are film-formed by the reactive sputtering using the silicon (Si) as the material, and the high refractive index layer 42 is film-formed by the reactive sputtering using the niobium (Nb) as the material. The semimetal shows the silicon (Si).

In the reactive sputtering, a mixed gas of the inert gas and oxygen (reactive gas) is used as the above-described gas. By adjusting a mixing ratio (volume ratio) of the inert gas to the oxygen, the ratio of the oxygen contained in the metal oxide layer to be film-formed can be adjusted. The volume ratio of the inert gas to the oxygen (volume of the oxygen when the volume of the inert gas is set to 100) is, for example, 3 to 50.

Examples of a power source for the sputtering method include DC power sources, AC power sources, RF power sources, and MF-AC power sources (AC power sources with a frequency band of tens to hundreds of MHz). The discharging power in the sputtering method is, for example, 0.05 kW to 40 kW. Further, the atmospheric pressure in the film forming chamber upon introduction of the gas (inert gas and/or oxygen) is, for example, 0.01 Pa to 2 Pa. A film forming temperature is, for example, −20° C. to 40° C.

The water-repellent layer 5 can be formed by film-forming the material for the water-repellent layer 5 on the reflection adjustment layer 4. Examples of a method for film-forming of the water-repellent layer 5 include dry coating methods and wet coating methods. Examples of the dry coating method include vacuum deposition methods, sputtering methods, and CVD, and preferably, a vacuum deposition method is used.

In the vacuum deposition method, the material for the water-repellent layer 5 is dried and solidified to be used as a vapor deposition source and by heating it, the material for the water-repellent layer 5 is vapor-deposited on the reflection adjustment layer 4. A heating temperature of the vapor deposition source is not particularly limited as long as it is a temperature at which the material for the water-repellent layer 5 can be evaporated, and is, for example, 150° C. to 500° C. As the method for film-forming of the water-repellent layer 5, when the dry coating method (vacuum deposition method) is used, the sputter film forming apparatus (magnetron sputter film forming apparatus) can be used which is capable of carrying out the film forming process in the roll-to-roll method. At this time, the metal reflective layer 3, the reflection adjustment layer 4, and the water-repellent layer 5 can be formed in series.

In the wet coating method, a solvent (for example, a fluorine-based solvent) is added to the material for the water-repellent layer 5 to be diluted, thereby preparing a water-repellent layer composition. Then, the water-repellent layer composition is coated onto one surface in the thickness direction of the reflection adjustment layer 4 to be dried, thereby forming the water-repellent layer 5. The drying temperature is, for example, 50° C. to 120° C. Further, the drying time is, for example, 10 seconds to 10 minutes.

As described above, it is possible to produce the film mirror laminate 1.

### Function and Effect

The above-described film mirror laminate 1 includes the substrate film 2, the metal reflective layer 3, the reflection adjustment layer 4, and the water-repellent layer 5 in order toward one side in the thickness direction; the reflection adjustment layer 4 includes the silicon oxide layer 43; the water-repellent layer 5 is disposed on one surface in the thickness direction of the silicon oxide layer 43; and the water contact angle in one surface in the thickness direction of the water-repellent layer 5 is 110° or more. Therefore, it is possible to suppress the corrosion of the metal reflective layer, and to suppress the decrease in the adhesion between the layers.

Specifically, the water contact angle in one surface in the thickness direction of the water-repellent layer 5 is 110° or more, and the water-repellent layer 5 has the high water repellency. Therefore, even when the water droplets (tap water droplets) adhere, it is possible to suppress the corrosion of the metal reflective layer 3. Consequently, it is possible to suppress the decrease in the adhesion between the layers which is derived from the corrosion of the metal reflective layer

The corrosion of the metal reflective layer 3 is generated, for example, by chloride ions (Cl⁻) contained in the tap water or in the atmosphere. Specifically, a natural oxidized film (for example, Al₂O₃ film) on the surface of the metal reflective layer 3 is locally destroyed by Cl⁻, and pitting corrosion proceeds starting from the portion. Since the Cl-clusters in the portion where the pitting corrosion proceeds, the chloride concentration becomes high, and the material (for example, Al) for the metal reflective layer 3 is dissolved. In this way, the corrosion of the metal reflective layer 3 proceeds.

### 2. Mirror Member

One embodiment of the mirror member 10 of the present invention is described with reference to FIG. 2.

The mirror member 10 includes, for example, a support substrate 6, a pressure-sensitive adhesive layer 7, and the above-described film mirror laminate 1 in order toward one side in the thickness direction. Specifically, as shown in FIG. 2, the mirror member 10 includes the support substrate 6, the pressure-sensitive adhesive layer 7 disposed on one surface in the thickness direction of the support substrate 6, and the film mirror laminate 1 disposed on one surface in the thickness direction of the pressure-sensitive adhesive layer 7. At this time, one surface in the thickness direction of the pressure-sensitive adhesive layer 7 is in contact with the other surface in the thickness direction of the film mirror laminate 1 (exposed surface of the substrate film 2). One surface in the thickness direction of the mirror member 10 (top most layer) is the water-repellent layer 5.

The mirror member 10 may have the film shape (including the sheet shape) or may have a plate shape. Further, the mirror member 10 extends in the plane direction perpendicular to the thickness direction.

### <Support Substrate>

The material for the support substrate 6 is not particularly limited and is appropriately selected in accordance with the application of the mirror member 10. Examples of the material for the support substrate 6 include resins, glass, and metals. As the material for the support substrate 6, from the viewpoint of the flexibility, preferably, a resin is used. Examples of the resin include polyester resins such as polyethylene terephthalate, polybutylene terephthalate, and polyethylene naphthalate, olefin resins such as polyethylene, polypropylene, and cycloolefin polymers, (meth) acrylic resins (acrylic resins and/or methacrylic resins), polycarbonate resins, polyether sulfone resins, polyarylate resins, melamine resins, polyamide resins, polyimide resins, polystyrene resins, norbornene resins, cellulose resins, and polyvinyl alcohol resins.

The thickness of the support substrate 6 is not particularly limited, and is appropriately selected in accordance with the application of the mirror member 10. The thickness of the support substrate 6 is, for example, 15 μm to 150 μm.

Dimensions of the support substrate 6 (length in the first direction and length in the second direction) are not particularly limited, and are appropriately selected in accordance with the application of the mirror member 10. The length in the first direction of the support substrate 6 is, for example, the length in the first direction of the film mirror laminate 1 or more. Further, the length in the second direction of the support substrate 6 is, for example, the length in the second direction of the film mirror laminate 1 or more.

### <Pressure-Sensitive Adhesive Layer>

An example of the material for the pressure-sensitive adhesive layer 7 includes a pressure-sensitive adhesive composition described in Japanese Unexamined Patent Publication No. 2023-110548.

The thickness of the pressure-sensitive adhesive layer 7 is not particularly limited as long as the support substrate 6 and the film mirror laminate 1 can be bonded to each other, and is, for example, 5 μm to 100 μm.

### <Method for Producing Mirror Member>

The above-described mirror member 10 can be produced by preparing the pressure-sensitive adhesive layer 7 (pressure-sensitive adhesive sheet) and attaching the support substrate 6 to the film mirror laminate 1 via the pressure-sensitive adhesive layer 7.

In other words, the method for producing the mirror member 10 includes, for example, a step of preparing the pressure-sensitive adhesive layer 7 (pressure-sensitive adhesive sheet) and a step of attaching the support substrate 6 to the film mirror laminate 1 via the pressure-sensitive adhesive layer 7.

The pressure-sensitive adhesive layer 7 is, for example, prepared by the method described in Japanese Unexamined Patent Publication No. 2023-110548. Specifically, the pressure-sensitive adhesive layer 7 is prepared by the method described in Examples to be described later. At this time, the pressure-sensitive adhesive layer 7 is prepared by a laminate (first release liner/pressure-sensitive adhesive layer/second release liner) in which the pressure-sensitive adhesive layer 7 is sandwiched between the first release liner and the second release liner.

The support substrate 6 and the film mirror laminate 1 are attached to each other via the pressure-sensitive adhesive layer 7 obtained by peeling the first release liner and the second release liner from the above-described laminate. Specifically, one surface in the thickness direction of the support substrate 6 is attached to the other surface in the thickness direction of the film mirror laminate 1 (exposed surface of the transparent resin film 21) via the pressure-sensitive adhesive layer 7.

As described above, it is possible to produce the mirror member 10.

### Function and Effect

The above-described mirror member 10 includes the above-described film mirror laminate 1. Therefore, it is possible to suppress the corrosion of the metal reflective layer 3, and to suppress the decrease in the adhesion between the layers. As a result, the reliability of the mirror member 10 is improved.

### Application

Examples of the application of the above-described film mirror laminate 1 and the above-described mirror member 10 include vehicle structural components, vehicle-mounted goods such as a head-up display, casing of electronic devices, casing of the home appliances, structural components, mechanical parts, various automotive parts, electronic devices parts, household goods applications such as furniture and kitchen goods, medical equipment, parts of building materials, and exterior parts. The above-described film mirror laminate 1 and the above-described mirror member 10 are more preferable for head-up display applications.

### EXAMPLES

Next, the present invention is further described based on Examples, Comparative Examples, and Reference Examples below. The present invention is however not limited by these Examples, Comparative Examples, and Reference Examples. The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”

### Example 1

### Preparation Step

By mixing 100 parts by mass (in terms of solid content) of acrylic urethane resin (trade name: BEAMSET 577, ultraviolet curable resin, manufactured by Arakawa Chemical Industries, Ltd.) containing silica particles having a number average primary particle size of 50 nm, 3.0 parts by mass of photopolymerization initiator (trade name: Omnirad 127, manufactured by IGM Resins B.V.), and 0.15 parts by mass of silicone-based leveling agent (trade name: POLYFLOW LE303, manufactured by Kyoeisha Chemical Co., Ltd.), and diluting the obtained mixture with butyl acetate, a curable resin composition having the solid content concentration of 30% by weight was obtained. The curable resin composition was coated onto one surface in the thickness direction of a polyethylene terephthalate film (PET film) (trade name: Lumirror (registered trademark) #50-U48, manufactured by TORAY INDUSTRIES, INC.) having the thickness of 50 μm so that the thickness thereof after drying became 1.5 μm, thereby forming a coating film. The obtained coating film was dried by heating at 60° C. for 60 seconds. Thereafter, by using a high-pressure mercury lamp, the ultraviolet ray at the wavelength of 365 nm and the integrated amount of light of 300 mJ/cm² was irradiated, so that the coating film was cured, thereby forming a hard coat layer (HC layer). In this way, the substrate film including the HC layer (cured resin layer) on the PET film (transparent resin film) was obtained.

### (Metal Reflective Layer Forming Step)

First, one surface in the thickness direction of the substrate film (one surface in the thickness direction of the HC layer) was subjected to the plasma treatment. In the plasma treatment, the sputter film forming apparatus (magnetron sputter film forming apparatus) in the roll-to-roll method was used. The sputter film forming apparatus included the film forming chamber capable of carrying out the film forming process, while running a work film (substrate film) in the roll-to-roll method. After the film forming chamber of the sputter film forming apparatus was evacuated to vacuum so that the degree of ultimate vacuum reached 1.0×10⁻⁴ Pa, the argon as the sputtering gas (inert gas) was introduced into the film forming chamber, and one surface in the thickness direction of the HC layer was subjected to the plasma treatment, while the substrate film was conveyed with the atmospheric pressure in the film forming chamber of 2.0 Pa and the effective power density of 0.50 W·min/cm²·m. The effective power density was the value obtained by dividing the power density (W/cm²) of the plasma outlet by the conveyance rate (m/min) of the work film by the roll-to-roll method.

Next, an aluminum layer (Al layer) having the thickness of 50 nm was formed on one surface in the thickness direction of the substrate film (one surface in the thickness direction of the HC layer) by the sputtering method. In the forming of the Al layer (metal reflective layer), the sputter film forming apparatus (magnetron sputter film forming apparatus) in the roll-to-roll method was used. The sputter film forming apparatus included the film forming chamber capable of carrying out the film forming process, while running the work film (substrate film) in the roll-to-roll method. The details of the sputter film forming conditions in the forming of the Al layer were shown below.

After the film forming chamber of the sputter film forming apparatus was evacuated to vacuum so that the degree of ultimate vacuum reached 1.0×10⁻⁴ Pa, the argon as the sputtering gas was introduced into the film forming chamber, and the atmospheric pressure in the film forming chamber was set at 0.3 Pa. Further, the aluminum was used as the target of the sputter film forming apparatus. As the power source for applying a voltage to the target, the MF-AC power source was used, the discharging power was 14 kW, and the film forming temperature was 25° C.

In this way, the Al layer was formed on one surface in the thickness direction of the substrate film (one surface in the thickness direction of the HC layer).

### (Reflection Adjustment Layer Forming Step)

Next, the reflection adjustment layer including the first silicon oxide layer (the first layer) having the thickness of 68 mm, the niobium oxide layer (the second layer) having the thickness of 53 nm, and the second silicon oxide layer (the third layer) having the thickness of 20 nm in order toward one side in the thickness direction was formed on one surface in the thickness direction of the Al layer by the sputtering method (reactive sputtering method). In the forming of the reflection adjustment layer, the sputter film forming apparatus (magnetron sputter film forming apparatus) in the roll-to-roll method was used. The sputter film forming apparatus included the film forming chamber capable of carrying out the film forming process, while running the work film (substrate film including the metal reflection layer) in the roll-to-roll method. The details of the sputter film forming conditions in the forming of the reflection adjustment layer were shown below.

In the film-forming of the first layer, after the film forming chamber of the sputter film forming apparatus was evacuated to vacuum so that the degree of ultimate vacuum reached 1.0×10⁻⁴ Pa, the argon as the sputtering gas (inert gas) and the oxygen as the reactive gas were introduced into the film forming chamber, and the atmospheric pressure in the film forming chamber was set at 0.3 Pa. The argon and the oxygen were introduced into the film forming chamber so that the volume ratio of the argon to the oxygen was 100 to 11. Further, the niobium (Nb) was used as the target of the sputter film forming apparatus. As the power source for applying the voltage to the target, the MF-AC power source was used, the discharging power was 20 kW, and the film forming temperature was 25° C.

In the film-forming of the second layer, after the film forming chamber of the sputter film forming apparatus was evacuated to vacuum so that the degree of ultimate vacuum reached 1.0×10⁻⁴ Pa, the argon as the sputtering gas (inert gas) and the oxygen as the reactive gas were introduced into the film forming chamber, and the atmospheric pressure in the film forming chamber was set at 0.3 Pa. The argon and the oxygen were introduced into the film forming chamber so that the volume ratio of the argon to the oxygen was 100 to 33. Further, the silicon (Si) was used as the target of the sputter film forming apparatus. As the power source for applying the voltage to the target, the MF-AC power source was used, the discharging power was 17 kW, and the film forming temperature was 25° C.

The film forming of the third layer used the same conditions as the above-described film forming of the first layer.

In this way, the reflection adjustment layer including the first silicon oxide layer (the first layer), the niobium oxide layer (the second layer), and the second silicon oxide layer (the third layer) in order toward one side in the thickness direction was formed on one surface in the thickness direction of the metal reflective layer.

### (Water-Repellent Layer Forming Step)

Thereafter, the water-repellent layer having the thickness of 5 nm was formed on one surface in the thickness direction of the reflection adjustment layer (one surface in the thickness direction of the second silicon oxide layer (the third layer)) by the vacuum deposition method as one of the dry coating methods (DC methods). As the material for the water-repellent layer, the material obtained by drying a water-repellent layer material (trade name: SHIN-ETSU SUBELYN KY1903-1, effective component: alkoxysilane compound containing the perfluoropolyether skeleton, manufactured by Shin-Etsu Chemical Co., Ltd.) was used as the vapor deposition source, and the heating temperature of the vapor deposition source was set at 260° C.

In this way, the water-repellent layer having the thickness of 5 nm was formed on one surface in the thickness direction of the reflection adjustment layer (one surface in the thickness direction of the second silicon oxide layer (the third layer))

As described above, the film mirror laminate of Example 1 whose top most surface layer (layer disposed on one surface in the thickness direction of the reflection adjustment layer) was the water-repellent layer was fabricated.

The thickness of the water-repellent layer formed by the DC method such as Example 1 and Examples 2 and 3 to be described later was measured by the following steps. As for the water-repellent layer to be measured (Examples 1 to 3), fluorescent X-ray intensity of the fluorine was measured using a fluorescent X-ray analyzer (trade name: ZSX-PRIMUS II, measurement size: ¢30 mm, manufactured by Rigaku Corporation). As a measurement standard, the water-repellent layer formed in Example 4 to be described later was used. Then, the thickness of the water-repellent layer to be measured was calculated from fluorescent X-ray intensity I1 of the fluorine of the water-repellent layer to be measured, fluorescent X-ray intensity 12 of the fluorine of the water-repellent layer (Example 4) as the measurement standard, and the thickness (7 nm) of the water-repellent layer (Example 4) as the measurement standard by the following formula.

Thickness of water-repellent layer to be measured=thickness of water-repellent layer as measurement standard×I1/I2

### Examples 2 and 3

As shown in Table 1, the film mirror laminates of Examples 2 and 3 were fabricated in the same manner as the film mirror laminate of Example 1, except that the thickness of the water-repellent layer was changed.

### Example 4

The film mirror laminate of Example 4 was fabricated in the same manner as the film mirror laminate of Example 1, except that the water-repellent layer forming step was changed as follows.

### (Water-Repellent Layer Forming Step)

The water-repellent layer having the thickness of 7 nm was formed on one surface in the thickness direction of the reflection adjustment layer (one surface in the thickness direction of the second silicon oxide layer (the third layer)) by the wet coating method (WC method). Specifically, the fluorine-based solvent (trade name: Fluorinert, manufactured by 3M Company) was added to the water-repellent layer material (trade name: SHIN-ETSU SUBELYN KY1903-1, effective component: alkoxysilane compound containing the perfluoropolyether skeleton, manufactured by Shin-Etsu Chemical Co., Ltd.), thereby preparing the water-repellent layer composition having the solid content concentration of 0.10% by volume. The water-repellent layer composition was coated onto one surface in the thickness direction of the reflection adjustment layer (one surface in the thickness direction of the silicon oxide layer (the third layer)) using a wire bar, and dried at 60° C. for 2 minutes, thereby forming the water-repellent layer having the thickness of 7 nm (calculated value).

In addition, in the water-repellent layer formed by the WC method such as Examples 4 and 5 and Comparative Example 3, the WET thickness (thickness before drying) was measured using a spectroscopic film thickness meter (trade name: MCPD-3000, manufactured by Otsuka Electronics Co., Ltd.), and the thickness after drying was calculated from the WET thickness by the following formula.

Thickness after drying=WET thickness×solid content concentration (% by volume)

### Example 5

As shown in FIG. 1, the film mirror laminate of Example 5 was fabricated in the same manner as the film mirror laminate of Example 4, except that the thickness of the water-repellent layer was changed.

### Comparative Example 1

The film mirror laminate of Comparative Example 1 was fabricated in the same manner as the film mirror laminate of Example 1, except that the water-repellent layer was not formed. That is, in Comparative Example 1, another layer was not provided on one surface in the thickness direction of the reflection adjustment layer.

### Comparative Example 2

The film mirror laminate of Comparative Example 2 was fabricated in the same manner as the film mirror laminate of Example 1, except that the HC layer having the thickness of 5 μm was formed instead of the water-repellent layer. The HC layer was the same as the one formed on the transparent resin film. The top most surface layer of Comparative Example 2 was the HC layer.

### Comparative Example 3

The film mirror laminate of Comparative Example 3 was fabricated in the same manner as the film mirror laminate of Example 1, except that the water-repellent layer forming step was changed as follows.

### (Water-Repellent Layer Forming Step)

The water-repellent layer having the thickness of 9 nm was formed on one surface in the thickness direction of the reflection adjustment layer (one surface in the thickness direction of the second silicon oxide layer (the third layer)) by the wet coating method (WC method). Specifically, the fluorine-based solvent (trade name: Novec 7300, manufactured by 3M Company) was added to the water-repellent layer material (trade name: OPTOOL DSX, effective component: fluorine-based compound and perfluorohexane, manufactured by Shin-Etsu Chemical Co., Ltd.) to be diluted to four hundredth, thereby preparing the water-repellent layer composition having the solid content concentration of 0.05%. The water-repellent layer composition was coated onto one surface in the thickness direction of the reflection adjustment layer (one surface in the thickness direction of the silicon oxide layer (the third layer)) using the wire bar, and dried at 60° C.) for 2 minutes, thereby forming the water-repellent layer having the thickness of 9 nm. The top most surface layer of Comparative Example 3 was the water-repellent layer.

### [Water Contact Angle]

In each of the film mirror laminates of Examples and Comparative Example 3, the water contact angle in one surface in the thickness direction of the water-repellent layer was measured. Specifically, 4.0 μL of water was added dropwise on one surface in the thickness direction of the water-repellent layer, and in two seconds after the dropping, an angle between the surface of the water-repellent layer and the tangential line at the end of the liquid droplet was measured using a contact angle measurement device (trade name: DMo-701, manufactured by Kyowa Interface Science, Co., Ltd.). The results are shown in Table 1. As for Comparative Examples 1 and 2, since the water-repellent layer was not provided, the water contact angle was not measured.

### [Water Dropping Corrosion Test]

The pressure-sensitive adhesive layer obtained by the following method was attached to the other surface in the thickness direction of each of the film mirror laminates of Examples and Comparative Examples (exposed surface of the transparent resin film). Then, the film mirror laminate was attached to glass (trade name: S200423, manufactured by Matsunami Glass Ind., Ltd.) having a size of 165 mm×65 mm via the pressure-sensitive adhesive layer. Next, 5 mL drops of tap water were added dropwise onto one surface in the thickness direction of the film mirror laminate (exposed surface at the opposite side of the surface attached to the glass) using a droplet, and fed into a thermos-hygrostat (manufactured by ESPEC Corp.) with the surface of drops of water facing directly up to be left to stand under the conditions of 60° C. and 95% RH for 500 hours. In 500 hours, one surface in the thickness direction of the film mirror laminate (surface on which the water was added dropwise) was visually checked and evaluated by the following criteria. The results are shown in Table 1.

### {Criteria}

A: Absence of corrosion (substrate film was not exposed)
B: Presence of corrosion (substrate film was exposed because the metal reflective layer was corroded and peeled)

### (Fabrication of Pressure-Sensitive Adhesive Sheet)

### [Preparation of Oligomer Composition]

As a monomer component, 60 parts by mass of dicyclopentanyl methacrylate; 40 parts by mass of methyl methacrylate; as a chain transfer agent, 3.5 parts by mass of a-thioglycerol; and as a polymerization solvent, 100 parts by mass of toluene were mixed, and stirred under a nitrogen atmosphere at 70° C. for one hour. Next, as the thermal polymerization initiator, 0.2 parts by mass of 2,2′-azobisisobutyronitrile was charged, reacted at 70° C. for two hours, and then, the temperature was increased to 80° C. to be reacted for two hours. Thereafter, the obtained reaction solution was heated to 130° C., and the toluene, the chain transfer agent, and an unreacted monomer component were dried and removed, thereby obtaining a solid acrylic oligomer. A weight average molecular weight of the acrylic oligomer was 5100, and a glass transition temperature (Tg) was 130° C.

### [Preparation of Prepolymer Composition]

As the monomer component, 67 parts by mass of 2-ethylhexyl acrylate; 15 parts by mass of N-vinyl-2-pyrrolidone; 3 parts by mass of hydroxyethyl acrylate; 15 parts by mass of 4-hydroxybutylacrylate; and as the photopolymerization initiator, 0.05 parts by mass of Irgacure 651 (trade name, manufactured by BASF SE) and 0.05 parts by mass of Irgacure 184 (trade name, manufactured by BASF SE) were mixed, and thereafter, the obtained monomer mixture was partially photopolymerized by exposure to the ultraviolet ray under the nitrogen atmosphere, thereby obtaining a prepolymer composition (polymerization ratio: about 10%).

### [Preparation of Pressure-Sensitive Adhesive Composition]

The pressure-sensitive adhesive composition was obtained by adding 5 parts by mass of oligomer composition, 0.3 parts by mass of 1,6-hexanediol diacrylate (trade name: “A-HD-N”, manufactured by SHIN-NAKAMURA CHEMICAL Co., Ltd.), and 0.3 parts by mass of silane coupling agent (trade name: “KBM-403”, manufactured by Shin-Etsu Chemical Co., Ltd.) to 100 parts by mass of the obtained prepolymer composition to be uniformly mixed. A gel fraction of the pressure-sensitive adhesive composition was 82%.

### [Fabrication of Pressure-Sensitive Adhesive Sheet]

A first release liner (trade name: DIAFOIL MRF75, PET film having a silicone-based release layer provided on the surface thereof, manufactured by Mitsubishi Chemical Group Corporation) having the thickness of 75 μm was prepared, and the pressure-sensitive adhesive composition was coated onto the surface of the release layer-side of the first release layer so that the thickness thereof after drying was 25 μm, thereby forming the coating layer. The surface which was subjected to the release treatment of the second release liner (trade name: DIAFOIL MRE75, PET film having one surface subjected to the silicone release treatment, manufactured by Mitsubishi Chemical Group Corporation) having the thickness of 75 μm was attached onto the coating layer so as to be in contact therewith. The ultraviolet ray was irradiated from the second release liner-side to the laminate thus obtained (first release liner/pressure-sensitive adhesive layer/second release liner) with the black light whose position was adjusted so that the irradiation intensity in the irradiated surface just directly under the lamp was 5 mW/cm². Then, the irradiated laminate was photocured. By peeling the first release liner and the second release liner, it can be used as the pressure-sensitive adhesive layer (pressure-sensitive adhesive sheet) having the thickness of 25 μm.

### [Reflection Rate]

The reflection rate of each of the film mirror laminates of Examples and Comparative Examples was measured using a spectrophotometer (trade name: CM-26d, manufactured by KONICA MINOLTA, INC.). The other surface in the thickness direction of the film mirror laminate (exposed surface of the transparent resin film) was attached to a black acrylic board having the size of 45 mm×50 mm via the pressure-sensitive adhesive layer obtained by the above-described method, thereby obtaining a measurement sample. The measurement was carried out from one side in the thickness direction of the film mirror laminate by irradiating the visible ray at the wavelength of 360 nm to 740 nm at an incident angle of 2°. The results are shown in Table 1.

### [Adhesion]

In each of the film mirror laminates of Examples and Comparative Examples, the adhesion was evaluated by a cross-cut test method based on JIS K 5400 of a cross-cut tape test. Specifically, the other surface in the thickness direction of the film mirror laminate (exposed surface of the transparent resin film) was attached to the glass (trade name: S200200, manufactured by Matsunami Glass Ind., Ltd.) having the size of 45 mm×50 mm via the pressure-sensitive adhesive layer obtained by the above-described method. Next, in one surface in the thickness direction of the film mirror laminate (exposed surface of the water-repellent layer), 11 cut was made vertically and horizontally at 10-mm intervals, the total of 100 squares in a grid shape were made, and tapes which were cut into about 15 mm in length (trade name: Sekisui Cellophane Tape No. 252, manufactured by Sekisui Chemical Company, Limited) were compressively bonded onto the squares in the grid shape. Thereafter, the edge of the tape was grasped and peeled in a 90° direction for 0 to 0.2 seconds. Further, the same procedure as described above (tape was compressively bonded and peeled) was repeated by changing the angle at 90°. The adhesion between the layers at this time was evaluated by the following criteria. The results are shown in Table 1. When 50% or more of the area of one square (1 cm²) was peeled, the square was determined to be peeled.

### {Criteria}

A: the number of peeled squares was 0
B: the number of peeled squares was 1 or more

TABLE 1

| | | | | | | Comp. | Comp. | Comp. |
|---|---|---|---|---|---|---|---|---|
| | Ex. 1 | Ex. 2 | Ex. 3 | Ex. 4 | Ex. 5 | Ex. 1 | Ex. 2 | Ex. 3 |
| Top Most | Water- | Water- | Water- | Water- | Water- | — | HC | Water- |
| Layer | Repellent | Repellent | Repellent | Repellent | Repellent | | Layer | Repellent |
| | Layer | Layer | Layer | Layer | Layer | | | Layer |
| Thickness | 5 nm | 6 nm | 7 nm | 7 nm | 9 nm | — | 50 μm | 9 nm |
| of Top | | | | | | | | |
| Most Layer | | | | | | | | |
| Water- | KY-1903-1 | | | | | — | — | OPTOOL |
| Repellent | | | | | | | | DSX |
| Layer Material | | | | | | | | |
| Water- | DC Method | | | WC Method | | — | — | WC |
| Repellent | | | | | | | | Method |
| Layer Forming | | | | | | | | |
| Method | | | | | | | | |
| Water Contact | 118 | 118 | 118 | 112 | 112 | — | — | 108 |
| Angle (°) | | | | | | | | |
| Water Dropping | A | A | A | A | A | B | B | B |
| Corrosion Test | | | | | | | | |
| Reflection | 96.5 | 96.5 | 96.5 | 96.5 | 96.5 | 96.5 | 93.9 | 96.5 |
| Rate (%) | | | | | | | | |
| Adhesion | A | A | A | A | A | B | B | B |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The above-described film mirror laminate 1 and the above-described mirror member 10 are, for example, preferably used in vehicle structural components, vehicle-mounted goods such as a head-up display, casing of electronic devices, casing of the home appliances, structural components, mechanical parts, various automotive parts, electronic devices parts, household goods such as furniture and kitchen goods, medical equipment, parts of building materials, and exterior parts. The above-described film mirror laminate 1 and the above-described mirror member 10 are more preferably used for head-up displays.

### DESCRIPTION OF REFERENCE NUMERALS

1 Film mirror laminate
2 Substrate film
3 Metal reflective layer
4 Reflection adjustment layer
5 Water-repellent layer
21 Transparent resin film
22 Cured resin layer
41 Low refractive index layer
42 High refractive index layer
43 Silicon oxide layer

1. A film mirror laminate comprising:
a substrate film, a metal reflective layer, a reflection adjustment layer, and a water-repellent layer in order toward one side in a thickness direction, wherein
the reflection adjustment layer includes a silicon oxide layer,
the water-repellent layer is disposed on one surface in the thickness direction of the silicon oxide layer, and
a water contact angle in one surface in the thickness direction of the water-repellent layer is 110° or more.

2. The film mirror laminate according to claim 1, wherein
a reflection rate of a visible ray at a wavelength of 360 to 740 nm irradiated from one side in the thickness direction of the film mirror laminate is 95.0% or more.

3. The film mirror laminate according to claim 1, wherein
the metal reflective layer includes at least one metal selected from the group consisting of aluminum (Al), zinc (Zn), lead (Pb), copper (Cu), and silver (Ag).

4. The film mirror laminate according to claim 1, wherein
the reflection adjustment layer includes a low refractive index layer, a high refractive index layer, and the silicon oxide layer in order toward one side in the thickness direction.

5. The film mirror laminate according to claim 1, wherein
the silicon oxide layer has a thickness of 50 nm or less.

6. The film mirror laminate according to claim 1, wherein
the water-repellent layer is a dry coating layer.

7. A mirror member comprising:
a support substrate, a pressure-sensitive adhesive layer, and the film mirror laminate according to claim 1 in order toward one side in a thickness direction.
